(19) United States
(12) Patent Application Publication
(10) Pub. No.: US 2026/0361076 A1
(43) Pub. Date: Nov. 12, 2026

(54) POWER DEVICE

(71) Applicant: DELTA ELECTRONICS (THAILAND) PUBLIC COMPANY LIMITED, Amphur Muang (TH)

(72) Inventors: Jun ZHANG, Shanghai (CN); Shiwei LIU, Shanghai (CN); Zhouxin WANG, Shanghai (CN); Xiaoqiang YU, Shanghai (CN)

(21) Appl. No.: 19/667,264

(22) Filed: May 4, 2026

(30) Foreign Application Priority Data
May 12, 2025 (CN) 202520926975.0

(51) Int. Cl. H02H 9/02; H01F 27/24; H02H 7/12; H02M 1/00; H02M 7/00

(52) U.S. Cl. CPC H02H 9/02; H01F 27/24; H02H 7/12; H02M 1/0038; H02M 7/003

(57) ABSTRACT

A power device includes an input terminal, a power conversion module, and an inductor. The input terminal is connected to a power supply bus and receives an input voltage. The power conversion module includes a terminal near the input terminal, and the terminal exhibits a capacitive impedance characteristic. The inductor is connected in series between the input terminal and the terminal of the power conversion module. When the input terminal is connected to the power supply bus, the inductor is used to suppress an inrush current flowing into the power conversion module.

### BACKGROUND

### Technical Field

The present disclosure relates to a power device, and more particularly to power device capable of suppressing an inrush current flowing into a power conversion module and limiting a drop of an input voltage.

### Description of Related Art

The statements in this section merely provide background information related to the present disclosure and do not necessarily constitute prior art.

With the rapid development of artificial intelligence (AI) and high-performance computing technologies, the power consumption of graphics processing units (GPUs) and central processing units (CPUs) in servers is also growing, thereby pushing the reliability standards of server power supply systems to face more stringent challenges. In the power supply structure, in order to meet the requirements of electromagnetic interference (EMI) suppression, a large number of capacitors are usually configured at the power input terminal. However, this topological characteristic causes the device to generate a large inrush current during the hot-plug power-on transient process. However, this topological characteristic causes a large inrush current during the hot-plug power-on transient as the capacitive impedance at the terminal charges rapidly. Such inrush current will form a significant voltage drop through the equivalent impedance of the power supply wire, thereby causing the input voltage to drop instantly. This voltage drop (disturbance) will be directly coupled to other parallel power devices in the system to cause the power supply unit to work abnormally, and even trigger cascade protection action in severe cases, thereby threatening the global stability of the data center power supply system.

The existing technology mainly uses a thermistor (PTC) in parallel with a switch (for example, MOSFET) as a soft-start circuit. During the power startup phase, the amplitude of the inrush current is limited by the high resistance state of the PTC, and after the system is stable, it switches to the low resistance path of the MOSFET to reduce power consumption. However, this structure has two key technical defects. First, the safety Y capacitor is a capacitive load directly connected between the power terminal and the protection ground, and its charging and discharging circuit is completely independent of the main power path, resulting in the inability of the existing inrush suppression circuit to suppress the inrush current caused by the safety Y capacitor. Second, the MOSFET switch has parasitic capacitance in the off state, which will generate additional inrush current at the moment of hot plugging and powering on the device. After superposition with the main inrush current, it will further aggravate the fluctuation amplitude of the power supply voltage.

Therefore, how to design a power device that can suppress the inrush current flowing into the power conversion module to limit the drop of the input voltage to solve the problems and technical bottlenecks in the existing technology has become a critical topic in this field.

### SUMMARY

An objective of the present disclosure is to provide a power device to solve the existing problems.

In order to achieve the above-mentioned objective, the present disclosure provides a power device. The power device includes an input terminal, a power conversion module, and an inductor. The input terminal is connected to a power supply bus and receives an input voltage. The power conversion module includes a terminal near the input terminal, and the terminal exhibits a capacitive impedance characteristic. The inductor is connected in series between the input terminal and the terminal of the power conversion module. When the input terminal is connected to the power supply bus, the inductor suppresses an inrush current flowing into the power conversion module.

In one embodiment, the inductor has characteristics of high initial magnetic permeability and high saturation magnetic flux density.

In one embodiment, a magnetic core of the inductor includes at least one magnetic material.

In one embodiment, a magnetic core of the inductor includes two magnetic materials.

In one embodiment, the two magnetic materials include a first magnetic material and a second magnetic material; one of the two magnetic materials has a characteristic of high initial magnetic permeability, and the other of the two magnetic materials has a characteristic of high saturation magnetic flux density.

In one embodiment, the magnetic material having the characteristic of high initial magnetic permeability includes any one of ferrite, amorphous alloy, nanocrystalline alloy, and permalloy, or a mixture of several of them; the magnetic material having the high saturation magnetic flux density includes any one of alloy powder core, cobalt-based amorphous alloy, silicon steel, and iron-based amorphous alloy, or a mixture of several of them.

In one embodiment, the first magnetic material and the second magnetic material are disposed side by side, and one side surface of the first magnetic material is fully adhered to an opposing side surface of the second magnetic material.

In one embodiment, the first magnetic material fully encapsulates the second magnetic material so that the second magnetic material is not visible from an external perspective.

In one embodiment, the first magnetic material is disposed within a hole structure of the second magnetic material to form a nested structure with inner and outer layers.

In one embodiment, when the input terminal is connected to the power supply bus, a voltage drop value (ΔV) of the input voltage and the inductance (L) satisfy the following relationship: ΔV=L1/(L1+L2+L)*(V_{bus}−V_{cap}), where V_{bus} is a bus voltage of the power supply bus, V_{cap} is a voltage on a capacitive impedance of the terminal, L1 is a first parasitic inductance between the power supply bus and the input terminal, and L2 is a second parasitic inductance between the input terminal and the terminal of the power conversion module.

In one embodiment, the power conversion module further includes a set of safety Y capacitors electrically connected to the inductor, and the inrush current includes a first inrush current flowing through the safety Y capacitors.

In one embodiment, the power conversion module further includes an inrush protection module and a safety X capacitor, and the inrush protection module is connected in series between the safety Y capacitor and the safety X capacitor.

In one embodiment, the inrush protection module further includes a current limit resistor and a switch connected in parallel, and the switch has a parasitic capacitance; the inrush current further includes a second inrush current flowing through the parasitic capacitance and the safety X capacitor.

In one embodiment, the input voltage is a DC voltage.

The present disclosure has the following features and advantages. The embodiments of the present disclosure provide the power device, and the inductor is connected in series between the input terminal of the power device and the power conversion module. When the device is hot-plugged into the power supply bus, the inductor suppresses the inrush current flowing into the power conversion module and limits the drop of the input voltage. Furthermore, by adopting a hybrid magnetic material solution to utilize the characteristics of different materials, the inductor with characteristics of high initial magnetic permeability and high saturation magnetic flux density is obtained, which has a better effect of suppressing inrush current, and furthermore, the size of the inductor can be reduced, thereby saving space for the power device.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a power device according to the present disclosure.

FIG. 2 is a schematic diagram of an equivalent inductance of using the power device according to the present disclosure.

FIG. 3 is a characteristic curve showing the change of inductance with current for two magnetic materials according to the present disclosure.

FIG. 4A is a perspective view of a configuration of multiple magnetic materials according to a first embodiment of the present disclosure.

FIG. 4B is a perspective view of a configuration of multiple magnetic materials according to a second embodiment of the present disclosure.

FIG. 4C is a perspective view of a configuration of multiple magnetic materials according to a third embodiment of the present disclosure.

FIG. 4D is a perspective view of a configuration of multiple magnetic materials according to a fourth embodiment of the present disclosure.

FIG. 4E is a perspective view of a configuration of multiple magnetic materials according to a fifth embodiment of the present disclosure.

FIG. 4F is a perspective view of a configuration of multiple magnetic materials according to a sixth embodiment of the present disclosure.

FIG. 5A is a circuit diagram of the inductor for suppressing inrush current according to a first embodiment of the present disclosure.

FIG. 5B is a circuit diagram of the inductor for suppressing inrush current according to a second embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

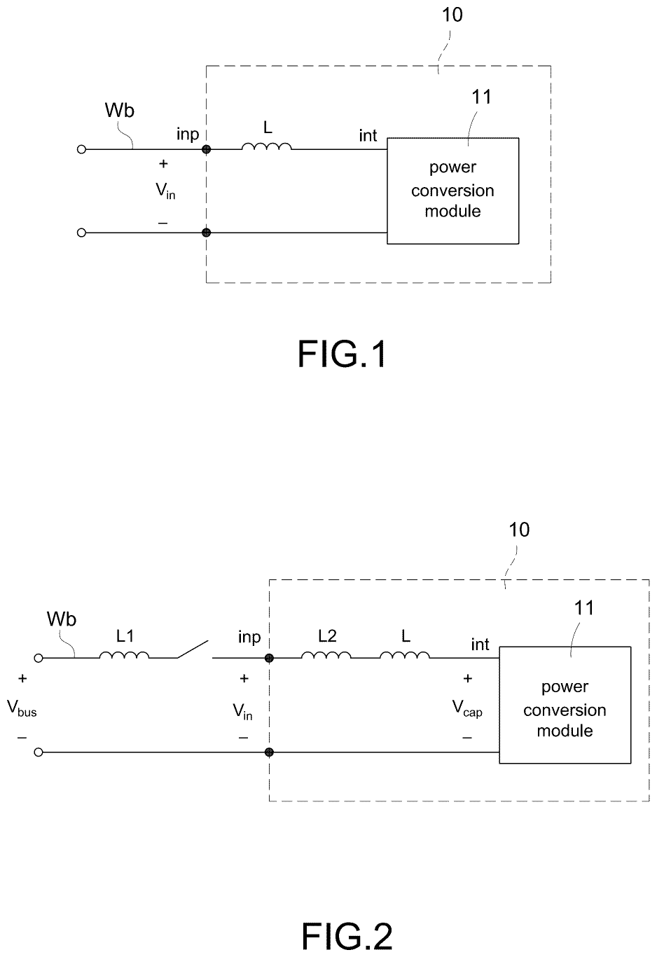

Please refer to FIG. 1, which shows a block circuit diagram of a power device according to the present disclosure. The power device 10 includes an input terminal inp, a power conversion module 11, and an inductor L. The input terminal inp is connected to a power supply bus Wb. In usual, the power supply bus Wb is a copper busbar structure, and the input terminal inp of the power device 10 can be hot-plugged into the power supply bus Wb to receive an input voltage Vᵢₙ. In particular, the input voltage Vᵢₙ is a DC (direct-current) voltage, but this is not intended to limit the present disclosure. In other words, the input voltage Vᵢₙ may also be an AC (alternating-current) voltage.

The power conversion module 11 includes a terminal int near the input terminal inp. The terminal int is used to receive the input voltage Vᵢₙ, and the input voltage Vᵢₙ is converted into a DC/AC voltage required by a load through the power conversion module 11. In usual, the power device 10 is equipped with an EMI filter at a terminal to filter out harmful electromagnetic interference between the power supply and the external environment, thereby ensuring that the device complies with electromagnetic compatibility standards. Since the EMI filter contains a large number of safety capacitors, the terminal int exhibits a capacitive impedance characteristic. The inductor L is connected in series between the input terminal inp and the terminal int of the power conversion module 11, that is, the inductor L is disposed inside the power device 10. Since the initial charge of the capacitive impedance of the terminal int is zero, in the power-on transient period when the input terminal inp is connected to the power supply bus Wb, the capacitive impedance of the terminal int is quickly charged to generate a large inrush current. Since the inductor L is connected in series between the input terminal inp and the terminal int of the power conversion module, an inrush current flowing into the power conversion module 11 can be suppressed and a drop of the input voltage Vᵢₙ can be limited.

Therefore, the core technology of the present disclosure is to configure an inductor L inside the power device 10, and utilize the effect of restraining the current change by the inductor L to reduce the inrush current and limit the drop of the input voltage Vᵢₙ.

Furthermore, the inductor L has characteristics of high initial magnetic permeability and high saturation magnetic flux density. The high initial magnetic permeability enables the inductor L to quickly establish high magnetic permeability under low magnetic field strength, thereby forming a large inductance value. With this characteristic, the inductor L can better prevent the inrush current from increasing at the beginning of power on. The high saturation magnetic flux density enables the inductor L to withstand a large magnetic field strength without saturation. When the inrush current is large or lasts for a long time, this characteristic ensures that the inductor L still maintains an effective inductance value under a strong magnetic field to avoid current limiting failure caused by saturation. The characteristics of high initial magnetic permeability and high saturation magnetic flux density can achieve the purpose of suppressing the inrush current flowing into the power conversion module 11 and limiting the drop of the input voltage Vᵢₙ at the same time. It should be noted that the selection of materials and parameters for inductor L featulayer high initial magnetic permeability and high saturation magnetic flux density in this embodiment shall be made in accordance with specific usage scenarios to achieve a balance between performance and reliability, which is not intended to limit the present disclosure.

Specifically, the magnetic core of the inductor L includes at least one magnetic material. Therefore, in one embodiment, the magnetic core of the inductor L may be a single magnetic material, which has characteristics of high initial magnetic permeability and high saturation magnetic flux density. Alternatively, the magnetic core of the inductor L includes two or more magnetic materials, for example, one of which has high initial magnetic permeability and the other has high saturation magnetic flux density. In other words, as long as a variety of magnetic materials can provide characteristics of high initial magnetic permeability and high saturation magnetic flux density, they can all be used as the inductor L of the present disclosure.

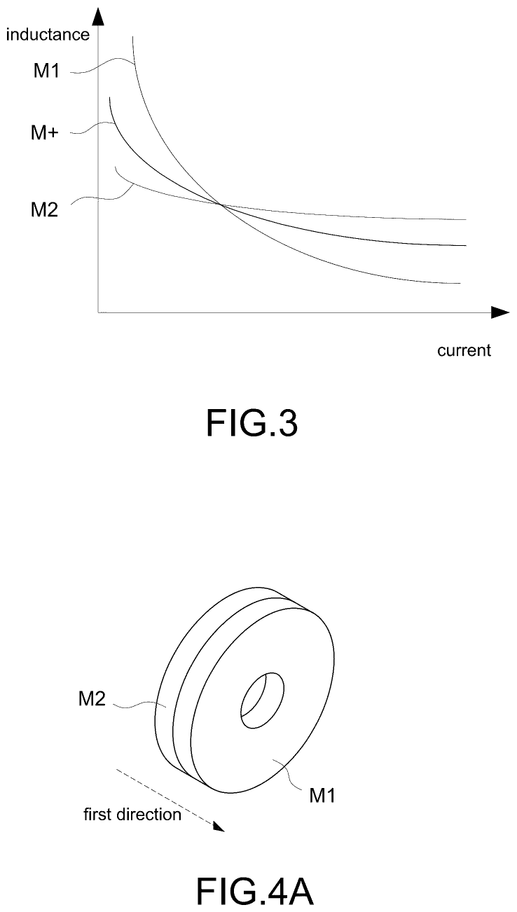

Please refer to FIG. 2, which shows a schematic diagram of an equivalent inductance of using the power device according to the present disclosure. The equivalent inductance shown in FIG. 2 is used to explain how the inductor L is used to limit a voltage drop value ΔV of the input voltage Vᵢₙ. As shown in FIG. 2, the voltage drop value ΔV and the inductance value of the inductor L (also represented by the symbol L) satisfy the following relationship. ΔV=L1/(L1+L2+L)*(V_{bus}−V_{cap}), where V_{bus} is a bus voltage of the power supply bus Wb, V_{cap} is a voltage on the capacitive impedance of the terminal int, L1 is a first parasitic inductance between the power supply bus Wb and the input terminal inp, and L2 is a second parasitic inductance between the input terminal inp and the terminal int of the power conversion module 11. In the present disclosure, the inductance value of the inductor L is designed to be much larger than the first parasitic inductance L1 and the second parasitic inductance L2 (i.e., L>>L1, L>>L2) so that the effect of limiting the voltage drop of the input voltage Vᵢₙ is better. In particular, Vᵢₙ in FIG. 2 is the input voltage of the input terminal inp, V_{bus} is the bus voltage of the power supply bus Wb, and the symbol of the switch in the figure is used to indicate that the input terminal inp of the power device 10 is connected to the power supply bus Wb (indicated by the switch being turned on) or not connected to the power supply bus Wb (indicated by the switch being turned off).

Therefore, in the present disclosure, the inductor L is connected in series between the input terminal inp and the terminal int of the power conversion module 11 to limit the voltage drop value ΔV of the input voltage Vᵢₙ. In the prior art without the inductor L, the voltage drop value of the input voltage Vᵢₙ will be ΔV′=L1/(L1+L2)*(V_{bus}−V_{cap}). Since the absence of the inductor L, it is clear that the voltage drop value ΔV′ of the input voltage Vᵢₙ will be greater than the voltage drop value ΔV of the input voltage Vᵢₙ using the inductor L in the present disclosure.

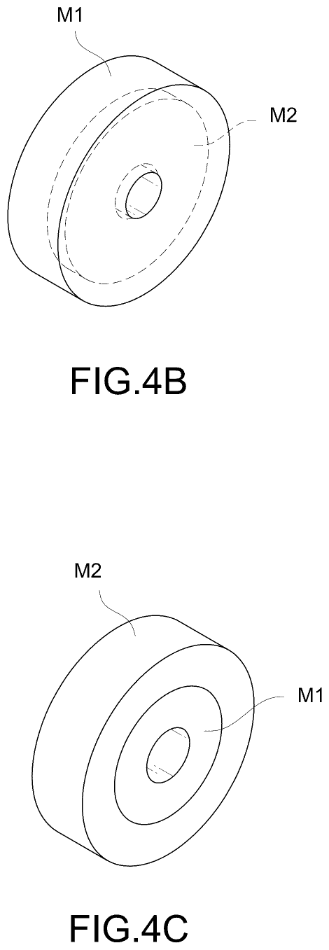

As for the magnetic core of the above-mentioned inductor L, which includes two magnetic materials or more than two magnetic materials, the specific description will be as follows. Please refer to FIG. 3, which shows a characteristic curve showing the change of inductance with current for two magnetic materials according to the present disclosure. In particular, the first magnetic material M1, such as ferrite, amorphous alloy, nanocrystalline alloy, permalloy, etc., has a characteristic of high initial magnetic permeability and can effectively enhance the inductance density while reducing the number of winding turns required. The second magnetic material M2, such as alloy powder core, cobalt-based amorphous alloy, silicon steel, iron-based amorphous alloy, etc., has a characteristic of high saturation magnetic flux density and can carry large current conditions and effectively avoid the redundant design of the core cross-sectional area. Therefore, when the two magnetic materials are combined as the magnetic core of the inductor L (called hybrid magnetic material M+), the advantages and characteristics of the two magnetic materials can be obtained, that is, the hybrid magnetic material M+ has characteristics of high initial magnetic permeability and high saturation magnetic flux density, which can better optimize inrush current and input voltage drop. Furthermore, the size of the inductor can be greatly reduced compared to a single material, thereby providing key technical support for the compact design of power supply systems with high power density. It should be noted that the materials listed here for the first magnetic material M1 and the second magnetic material M2 are not limited to this in the present disclosure.

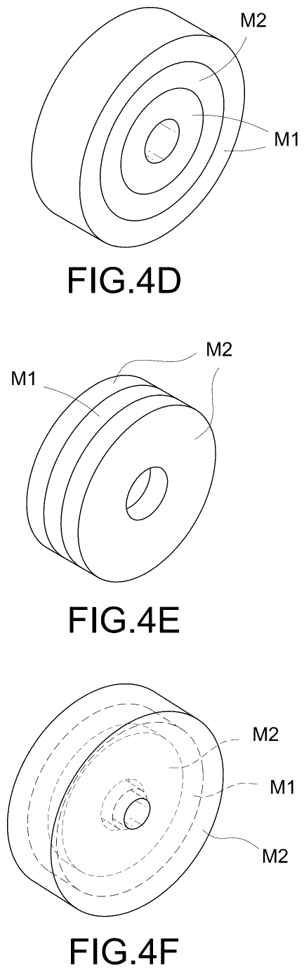

Please refer to FIG. 4A, which shows a perspective view of a configuration of multiple magnetic materials according to a first embodiment of the present disclosure. In the first embodiment, the magnetic core of the inductor L includes two magnetic materials, namely, the first magnetic material M1 and the second magnetic material M2. As mentioned above, the first magnetic material M1 has a characteristic of high initial magnetic permeability, and the second magnetic material M2 has a characteristic of high saturation magnetic flux density. In the first embodiment, the first magnetic material M1 and the second magnetic material M2 are arranged side by side along a first direction, and one side surface of the first magnetic material M1 is fully adhered to one side surface of the second magnetic material M2, that is, the first magnetic material M1 and the second magnetic material M2 are fully adhered to each other, forming a tightly integrated parallel structure with two layers.

Please refer to FIG. 4B, which shows a perspective view of a configuration of multiple magnetic materials according to a second embodiment of the present disclosure. In the second embodiment, the magnetic core of the inductor L includes two magnetic materials, namely, the first magnetic material M1 with high initial magnetic permeability and the second magnetic material M2 with high saturation magnetic flux density. In the second embodiment, the first magnetic material M1 fully encapsulates the second magnetic material M2 so that the second magnetic material M2 is not visible from an external perspective. Incidentally, although the first magnetic material M1 fully encapsulates the second magnetic material M2 in FIG. 4B, the magnetic core of the inductor L may also be composed of a structure in which the second magnetic material M2 fully encapsulates the first magnetic material M1, which can also have both characteristics of high initial magnetic permeability and high saturation magnetic flux density.

Please refer to FIG. 4C, which shows a perspective view of a configuration of multiple magnetic materials according to a third embodiment of the present disclosure. In the third embodiment, the magnetic core of the inductor L includes two magnetic materials, namely, the first magnetic material M1 with high initial magnetic permeability and the second magnetic material M2 with high saturation magnetic flux density. In the third embodiment, the first magnetic material M1 is disposed within a hole structure of the second magnetic material M2 to form a nested structure with inner and outer layers. Incidentally, although the first magnetic material M1 is disposed within the hole structure of the second magnetic material M2 in FIG. 4C, the magnetic core of the inductor L may also be composed of a structure in which the second magnetic material M2 is disposed within a hole structure of the first magnetic material M1, which can also have both characteristics of high initial magnetic permeability and high saturation magnetic flux density.

Please refer to FIG. 4D, which shows a perspective view of a configuration of multiple magnetic materials according to a fourth embodiment of the present disclosure. In the fourth embodiment, compared with the hybrid structure shown in FIG. 4C, a first magnetic material M1 is further nested outside the second magnetic material M2 to form a nested structure of three layers of M1, M2, and M1 from the innermost layer to the outermost layer. It is also conceivable that a second magnetic material M2 is further nested outside the outermost first magnetic material M1 to form a nested structure of four layers of M1, M2, M1, and M2 from the innermost layer to the outermost layer, and so on, no more details are given. Similarly, the second magnetic material M2 may be used as the innermost layer, and nested outward to form a nested structure of three layers of M2, M1, and M2 from the innermost layer to the outermost layer, or a nested structure of four layers of M2, M1, M2, and M1 from the innermost layer to the outermost layer.

Incidentally, the three-layer nested structure shown in FIG. 4D is illustrated by using two magnetic materials as an example, and is not intended to limit the present disclosure. That is, the three-layer nested structure may be composed of three magnetic materials, wherein due to hybrid characteristics of the three magnetic materials, both characteristics of high initial magnetic permeability and high saturation magnetic flux density can be achieved. It should be understood that at least one of the three magnetic materials should have the characteristic of high initial magnetic permeability and at least one should have the characteristic of high saturation magnetic flux density, and the rest may have the characteristic of high initial magnetic permeability or the characteristic of high saturation magnetic flux density or both.

Please refer to FIG. 4E, which shows a perspective view of a configuration of multiple magnetic materials according to a fifth embodiment of the present disclosure. In the fifth embodiment, compared with the hybrid structure shown in FIG. 4A, a second magnetic material M2 is further fully adhered to the other side surface of the first magnetic material M1 so that the first magnetic material M1 is sandwiched between the two second magnetic materials M2 to form a tightly integrated parallel structure with three layers. It is also conceivable that a first magnetic material M1 is further fully adhered to the other side of one of the two second magnetic materials M2 to form a tightly integrated parallel structure with four layers, and so on, no more details are given.

Incidentally, the tightly integrated parallel structure with three layers shown in FIG. 4E is illustrated using two magnetic materials as an example, but is not intended to limit the present. disclosure. That is, the tightly integrated parallel structure with three layers may be composed of three magnetic materials, wherein due to hybrid characteristics of the three magnetic materials, both characteristics of high initial magnetic permeability and high saturation magnetic flux density can be achieved.

Please refer to FIG. 4F, which shows a perspective view of a configuration of multiple magnetic materials according to a sixth embodiment of the present disclosure. In the sixth embodiment, compared with the hybrid structure shown in FIG. 4B, a second magnetic material M2 further fully encapsulates the first magnetic material M1 so that the outermost second magnetic material M2 encapsulates the first magnetic material M1, and the first magnetic material M1 further encapsulates the innermost second magnetic material M2, forming a tightly integrated encapsulating structure with three parts. It is also conceivable that a first magnetic material M1 further fully encapsulates the outermost second magnetic material M2, forming an encapsulating structure of four parts of M1, M2, M1, M2 from the outermost part to the innermost part, and so on, no more details are given. Similarly, the first magnetic material M1 may be used as the innermost part, and then encapsulated outward to form an encapsulating structure of M1, M2, M1 with three parts from the innermost part to the outermost part, or an encapsulating structure of M1, M2, M1, M2 with four parts from the innermost part to the outermost part.

Incidentally, the three-part encapsulating structure shown in FIG. 4F is illustrated by using two magnetic materials as an example, and is not intended to limit the present disclosure. That is, the three-part encapsulating structure may be composed of three magnetic materials, wherein due to hybrid characteristics of the three magnetic materials, both characteristics of high initial magnetic permeability and high saturation magnetic flux density can be achieved. It should be understood that at least one of the three magnetic materials should have the characteristic of high initial magnetic permeability and at least one should have the characteristic of high saturation magnetic flux density, and the rest may have the characteristic of high initial magnetic permeability or the characteristic of high saturation magnetic flux density or both.

Incidentally, although the present disclosure provides six embodiments of multiple magnetic material configurations in FIG. 4A to FIG. 4F to form the magnetic core of the inductor L, the present disclosure is not limited to these six embodiments. In other words, other embodiments not disclosed in FIG. 4A to FIG. 4F that have both characteristics of high initial magnetic permeability and high saturation magnetic flux density can also be used as the magnetic core of the inductor L required by the present disclosure.

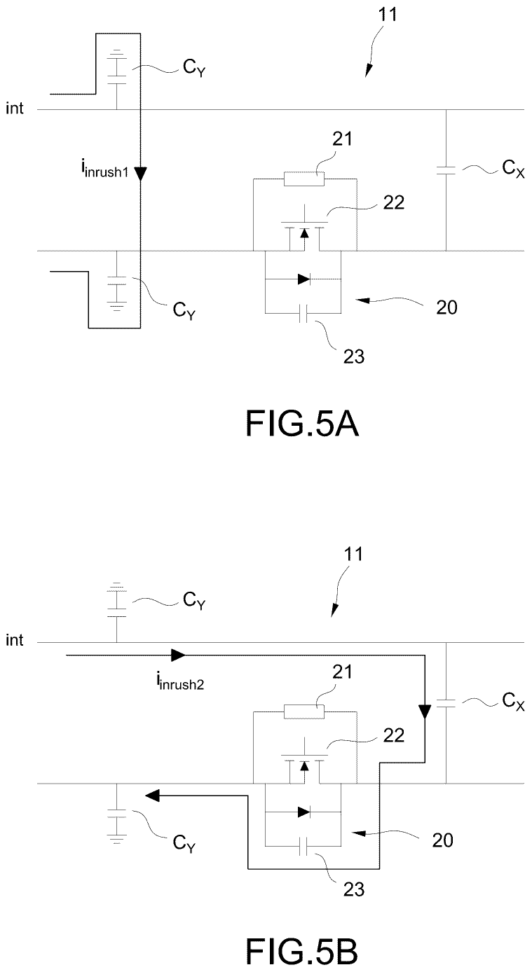

Please refer to FIG. 5A, which shows a circuit diagram of the inductor for suppressing inrush current according to a first embodiment of the present disclosure. It should be understood that for the convenience of explaining the technical solution of this embodiment, the figure only shows part of the circuit, and other circuits not directly related to this embodiment are not shown in the figure. In conjunction with FIG. 1, the power conversion module 11 further includes a set of safety Y capacitors C_{Y} electrically connected respectively between a live wire and a ground wire and between a neutral wire and the ground wire. When the power device 10 is not equipped with the inductor L, during the transient process of hot plugging the power supply bus Wb, a charging loop will be formed between the safety Y capacitor C_{Y} and the ground wire, resulting in a sharp generation of a first inrush current iᵢₙᵣᵤₛₕ₁ to cause a large voltage drop value of the input voltage Vᵢₙ. Therefore, the inductor L is connected in series between the input terminal inp and the terminal int of the power conversion module 11 (i.e., the front end of the set of safety Y capacitors). When the input terminal inp is connected to the power supply bus Wb, the inductor L can effectively suppress the first inrush current iᵢₙᵣᵤₛₕ₁ flowing into the power conversion module 11, thereby ensuring the normal operation of the device.

Please refer to FIG. 5B, which shows a circuit diagram of the inductor for suppressing inrush current according to a second embodiment of the present disclosure. It should be understood that for the convenience of explaining the technical solution of this embodiment, the figure only shows part of the circuit, and other circuits not directly related to this embodiment are not shown in the figure. In conjunction with FIG. 1, the power conversion module 11 further includes an inrush protection module 20 and a safety X capacitor C_{X}. The inrush protection module 20 is connected in series to the live wire or neutral wire between the safety Y capacitor C_{Y} and the safety X capacitor C_{X}. Specifically, the inrush protection module 20 includes a current limiting resistor 21 and a switch 22 connected in parallel, and the switch 22 has a parasitic capacitor 23. When the power device 10 is not equipped with an inductor L, during the transient process of hot plugging the power supply bus Wb, the parasitic capacitor 23 and the safety X capacitor C_{X} form a loop and charge rapidly, resulting in a sharp generation of a second inrush current iᵢₙᵣᵤₛₕ₂. Under this condition, the first inrush current iᵢₙᵣᵤₛₕ₁ and the second inrush current iᵢₙᵣᵤₛₕ₂ superimpose, causing a significant voltage drop in the input voltage Vᵢₙ. Therefore, the inductor L is connected in series between the input terminal inp and the terminal int of the power conversion module 11. When the input terminal inp is connected to the power supply bus Wb, the inductor L can also effectively suppress the second inrush current iᵢₙᵣᵤₛₕ₂ flowing into the power conversion module 11, thereby ensuring the normal operation of the device. After the parasitic capacitor 23 is fully charged, the current flows through the current limiting resistor 21, which further plays a current limiting role.

In summary, the present disclosure has the following features and advantages: by using the inductor to suppress the inrush current flowing into the power conversion module and limit a drop of the input voltage so that the problems existing in the prior art are solved.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power device comprising:
an input terminal connected to a power supply bus and configured to receive an input voltage,
a power conversion module comprising a terminal near the input terminal, and the terminal exhibiting a capacitive impedance characteristic, and
an inductor connected in series between the input terminal and the terminal of the power conversion module, wherein when the input terminal is connected to the power supply bus, the inductor is configured to suppress an inrush current flowing into the power conversion module.

2. The power device as claimed in claim 1, wherein the inductor has characteristics of high initial magnetic permeability and high saturation magnetic flux density.

3. The power device as claimed in claim 2, wherein a magnetic core of the inductor comprises at least one magnetic material.

4. The power device as claimed in claim 3, wherein a magnetic core of the inductor comprises two magnetic materials.

5. The power device as claimed in claim 4, wherein the two magnetic materials comprise a first magnetic material and a second magnetic material; one of the two magnetic materials has a characteristic of high initial magnetic permeability, and the other of the two magnetic materials has a characteristic of high saturation magnetic flux density.

6. The power device as claimed in claim 5, wherein the magnetic material having the characteristic of high initial magnetic permeability comprises any one of ferrite, amorphous alloy, nanocrystalline alloy, and permalloy, or a mixture of several of them; the magnetic material having the high saturation magnetic flux density comprises any one of alloy powder core, cobalt-based amorphous alloy, silicon steel, and iron-based amorphous alloy, or a mixture of several of them.

7. The power device as claimed in claim 5, wherein the first magnetic material and the second magnetic material are disposed side by side, and one side surface of the first magnetic material is fully adhered to an opposing side surface of the second magnetic material.

8. The power device as claimed in claim 5, wherein the first magnetic material fully encapsulates the second magnetic material so that the second magnetic material is not visible from an external perspective.

9. The power device as claimed in claim 5, wherein the first magnetic material is disposed within a hole structure of the second magnetic material to form a nested structure with inner and outer layers.

10. The power device as claimed in claim 1, wherein when the input terminal is connected to the power supply bus, a voltage drop value (ΔV) of the input voltage and the inductance (L) satisfy the following relationship:
ΔV=L1/(L1+L2+L)*(V_{bus}−V_{cap}), where V_{bus} is a bus voltage of the power supply bus, V_{cap} is a voltage on a capacitive impedance of the terminal, L1 is a first parasitic inductance between the power supply bus and the input terminal, and L2 is a second parasitic inductance between the input terminal and the terminal of the power conversion module.

11. The power device as claimed in claim 1, wherein the power conversion module further comprises a set of safety Y capacitors electrically connected to the inductor, and the inrush current comprises a first inrush current flowing through the safety Y capacitors.

12. The power device as claimed in claim 11, wherein the power conversion module further comprises an inrush protection module and a safety X capacitor, and the inrush protection module is connected in series between the safety Y capacitor and the safety X capacitor.

13. The power device as claimed in claim 12, wherein the inrush protection module further comprises a current limit resistor and a switch connected in parallel, and the switch has a parasitic capacitance; the inrush current further comprises a second inrush current flowing through the parasitic capacitance and the safety X capacitor.

14. The power device as claimed in claim 1, wherein the input voltage is a DC voltage.
